(19) United States
(12) Patent Application Publication
(10) Pub. No.: US 2022/0258089 A1
(43) Pub. Date: Aug. 18, 2022

(54) Activated Charcoal Air Ventilation System Filter

(71) Applicant: Darryl Cerro, Mooresville, NC (US)

(72) Inventor: Darryl Cerro, Mooresville, NC (US)

(21) Appl. No.: 17/174,966

(22) Filed: Feb. 12, 2021

(51) Int. Cl. B01D 46/38; B01D 46/00; B01D 39/06

(52) U.S. Cl. CPC B01D 46/38; B01D 46/0038; B01D 2279/40; B01D 2279/50; B01D 39/06

(57) ABSTRACT

A vacuum-fed filtration apparatus includes a filter/purifier housing having air inlets (through the screen) at the upper and lower portion of the filter housing and a loose activated charcoal bed within the lower interior portion of the filter housing. Activated charcoal is located in the interior cavity of the filter housing between the bottom and top screens, which feeds openings that enters the air chamber of the HVAC system. The vacuum forces the activated charcoal media to float in the inner cavity of the filter housing when the HVAC is activated. The upper and lower portion of the filter housing (mesh) is configured to prevent the activated charcoal from escaping the vessel.

### BACKGROUND

There has long been an unmet need for a means to filter indoor house air for health reasons and for odor reasons but the state of the art is lacking in many ways. Traditionally, home owners use dust filters to perform house odors cleaning, however, such home ventilation technologies still permit an undesirable odors and chemical contaminants through the surrounding environment of the home owner. As such, there is a need for a technology that solves the above mentioned problems with tightly sealed houses.

### FIELD OF THE INVENTION

The present invention is a device that suspends activated charcoal to filter the air in a column. Allows convenient replacement by downwardly removing the insert when changes are necessary.

EXAMPLE: This invention relates to an air filter vessel and more particularly to an air purifier mounted in the middle of an air chamber register of a whole house air inlet return grille.

### DETAILED DESCRIPTION

### Technical Field

The invention relates to vacuum-fed filtration system, and more specifically to a vacuum-fed air filtration system.

The rectangle charcoal air filter is carried on top of a dust filter which seals the inlet surface. The filter can be rectangle, square, or any other shape type without limitation that causes the activated charcoal to be suspended in the air column by a mesh structure. The position of the filter allows the upward airflow (vacuum) of the ventilation air current to suspend the activated charcoal in the air column. The bottom grill door is opened and the dust air filter is removed and the charcoal air purifier is placed on top of the dust filter and reinserted in the ceiling air inlet air return grill. A new charcoal purifier filter can easily be installed and repositioned in the operating position.

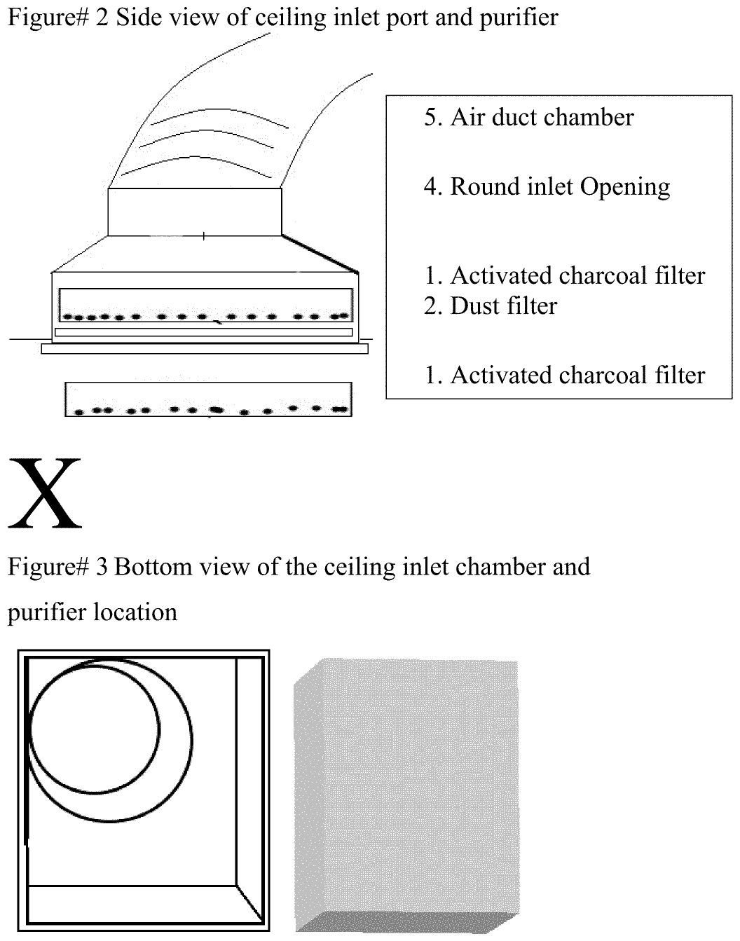

Incoming air flows through openings in the screen bottom and top of the mesh of the charcoal air purifier. Increasing the air flow increases the amount of purified air. From the air chamber, air flows through the ventilation unit and then into the room vents. (FIG. 2) Shows a side section view of the incoming air as it passes through the dust filter through the air passage. The air passes through the dust tray or MERV filter element which is shown in this view then through the activated charcoal filter into the air chamber.

In this rendition, the activated charcoal bed is levitated by a vacuum but can also be levitated by all sizes and shapes of fans without limitation blowing straight up the bottom of a mesh structure. This includes fans that can create a vacuum above the mesh structure with a reverse fan setting instead of blowing air.

The rectangle activated charcoal filter is located above the dust filter and inlet port receives the filter as shown in FIG. 2. The charcoal filter (1) bears against the top edges of dust filter (2) to form a seal in the inlet opening. The bottom of the activated charcoal air purifier covers most of the dust filter below it, and the sealing edges form a semi-seal on the dust filter tray (2).

The filter operates in the following described manner Referring to (FIG. 2), the charcoal filter element (1) is in the operating position in which the bottom side of the filter bears against the dust filter element. The inlet air goes up through the HVAC register inlet port first, then passes through the dust filter next (2), then through the through the activated charcoal mesh air purifier (1) into the opening to the inlet opening (4) of the HVAC system.

A new activated charcoal filter element (1) can again be reinstalled on top of the dust filter after removing the old activated charcoal air filter above the dust filter.

Air Duct Activated Charcoal Air Filter Assembly

Background: In the present world of ceiled homes with attendant pollution from chemical cleaners and odors, the need exists to provide extra precautionary means to insure that the air to which one is exposed is close to pure air as can be, even when living in a home.

This invention relates to an improved, easily replaceable air filter assembly as applied to the return grille of a ducted home air system. More particularly, the invention is directed to new improved manner of filtering return air that is directed into the interior of a home or building through its air conditioning, heating, and ventilation systems and includes an enclosed floatable bed of activated charcoal.

The return air grille sucks the air up through the dust filter and then through the activated charcoal filter which suspends the loose charcoal in the air column and cleans the polluted air. The object is to increase the supply of cleaned air to the interior rooms of a home, building and RV which provides control and regulation of the returned air.

A vacuum caused by the ventilation system can supply relatively large volumes of air into the interior rooms. The activated charcoal air purifier element will filter the interior air entering the return grille.

### BACKGROUND OF THE INVENTION

This filter system provides an inexpensive improved home air filter/air purifier device that can easily be adapted for use in a new as well as older home. Another object of this invention is to provide an improved device for ventilated air to a home to neutralize contaminants, odors or gases. The invention also provides an improved filter device to easily mount an air cleaner after the dust filter.

### DESCRIPTION OF THE BELOW ART

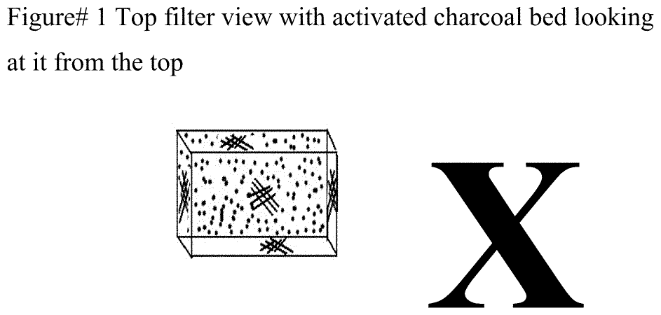

FIG. 1 is a top view 3D perspective of the screen filter with activated charcoal bed according to the present invention.

FIG. 2 is a side perspective view of the filter assembly entering the air intake register and 3D perspective.

FIG. 3 is the 3D perspective view of the bottom view of the ceiling air intake register.

### SUMMARY

Simple air purifier for home or business

Inexpensive air purifier that can be changed easily

### DESCRIPTION OF THE DEFERRED EMBODIMENT

Referring now to the drawing shown in FIG. 2, a screen made with 304 stainless steel strands but can be made of other metals, polyethylene, or any other plastic/polymer or any other natural type material without limitation, evenly woven to create a mesh box structure. All mesh structures are constructed with glue. The diameter and size of the air filter cavity depends on the width and height of the air chamber. A one-piece unit with loose activated carbon bed filter (10 mm) The filter bed preferably comprises a loose 10 mm activated charcoal layer that has been found to be helpful in filtering odors and gases and any other contaminants, which is one of the major problems of respiratory air inside the home.

I claim:

1. An air activated charcoal filter apparatus for home or business; comprising an air permeable mesh structure with a loose bed of activated charcoal inside the cavity.

2. A mesh structure having an air entry side (bottom) and an air exit side (top) wherein air flows through the screens or mesh from the upward directed air (vacuum), through the bottom of the filter.

3. The filter suspends or levitates the loose activated charcoal within the bed of a mesh structure in an air column to purify air directed with a vacuum from an air chamber of a HVAC ventilation system or by any fan pointing upward into the bottom of a mesh structure.

4. Suspended activated charcoal captures the maximum amount of air borne chemical contaminants, house hold cleaners, smoke and other odors from the air flowing through the filter.

5. Draws a high volume of air through the mesh structure with relatively low interference.

6. All mesh structures are constructed with glue.
